(19) United States
(12) Patent Application Publication
(10) Pub. No.: US 2008/0245249 A1
(43) Pub. Date: Oct. 9, 2008

(54) Stamp For Hot or Cold Stamping

(75) Inventor: Faust Mühlich, Süssen (DE)

Correspondence Address: Charles R. Hoffmann;Hoffmann & Baron, 6900 Jericho Turnpike, Syosset, NY, 11791, US

(73) Assignee: HINDERER & MÜHLICH KG, Goppingen (DE)

(21) Appl. No.: 10/593,363

(22) PCT Filed: Mar. 11, 2005
(86) PCT No.: PCT/DE2005/000439

§ 371 Date: Jan. 12, 2007

(30) Foreign Application Priority Data
Mar. 24, 2004 (DE) 10 2004 014 373.0

(51) Int. Cl. B41F 31/00

(52) U.S. Cl. 101/327

(57) ABSTRACT

A stamp die (10) having a surface structure (14, 16) for hot or cold stamping is described, said stamp die (10) being flexible such that it is no longer necessary during stamping to make the hitherto necessary adjustments for tolerance compensation by placing suitable materials under the substrate to be stamped or under the stamp die (10). Said flexibility is obtained in that the stamp die (10) has a use layer (12) with the surface structure (14, 16), a base layer (18) and at least one intermediate layer (20) between the use layer and the base layer (12 and 18), the layers (12, 20, 18) each being connected to one another by means of a heat-resistant flexible connecting film (22). Said connecting films (22) are preferably adhesive films.

The invention relates to a stamp die having a surface structure for hot stamping or for cold stamping.

During hot stamping, hot stamping foils, for example, are processed in order to produce, for example, graphic products or plastic parts. Stamp dies are used without foils during cold stamping. Said form of stamping is also referred to as blind stamping.

The surface structure can be an engraving or the like.

The known stamp dies which are used in the graphics industry are usually of compact, that is to say single-part design, and make it necessary to carry out so-called adjustments in order to compensate for tolerances of the substrate to be stamped, to compensate for tolerances of the stamping machine and/or to compensate for tolerances of the stamp die.

Compensating for said tolerances by means of adjustments is very expensive and accounts for a high proportion of the overall costs of the respective stamping process.

Said adjustments are carried out in working practice by placing suitable materials—of the required, that is to say different thicknesses in each case—under the substrate to be stamped or under the stamp die. This placement is time-consuming. It is also unsatisfactory that said adjustment is carried out on the basis of the experience of the operator and is consequently difficult or impossible to reproduce.

Stamp dies for hot stamping or dies for punching label paper or the like are known, said stamp dies having a base layer on which a use layer is provided. The use layer is composed, for example, of brass, copper or a photopolymer and can be engraved, etched, eroded or structured by means of a laser. The base layer is composed of a ferritic material in order to make it possible to magnetically clamp said known die to a machine table or a rotary body. With said known dies, it is therefore necessary only to form a motif, that is to say the surface structure, in an easily machinable use layer, and then to simply fixedly clamp the die magnetically to a machine table or a rotary body. In said known stamp dies, the use layer is mechanically rigidly connected to the base layer, for example by being rolled on. Another possibility is to apply the use layer to the base layer galvanically. This also results in a mechanically rigid connection of the use layer to the base layer. If appropriate, it is also possible for the surface-structured use layer to be adhered to the base layer in a mechanically fixed fashion. Such a double-layered design of the die, composed of the base layer and a surface-structured use layer, does not provide tolerance compensation.

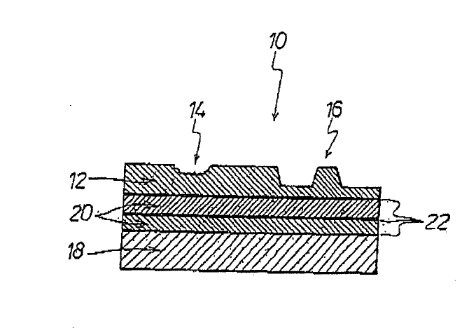

A stamp die having a die body with an elastic film is known from DE 1 161 568 B. The elastic film which forms the use layer of the stamp die can be formed to have a surface structure (FIG. 5 and associated description) or can be provided with a flexible metal surface (FIG. 1 and associated description). The elastic film can also have inserts, for example, in the form of metal foils (FIG. 3 and associated description). A stamp die having a use layer which is made from a hard material and has a surface structure is neither known from DE 1 161 568 B, nor is it suggested by said prior art.

DE 38 29 279 C2 discloses a stamp die, which has a use layer, for hot stamping. The use layer is composed of a rubber mixture and is heated by means of an electrical resistance heating element. A thermal insulation film can be provided on the rear side of the resistance heating element. A pressure pad adjoins the thermal insulation film. The pressure pad is capable of adapting its shape to the surface, which is to be imprinted, of a workpiece.

DE 198 35 993 A1 describes a stamp die for applying markings to workpieces. Said known stamp die has a letter holder, which serves to hold letters, between side shells. A rubber plate, as a pressure compensating means, and a die plate are arranged on the rear side of the letter holder.

The invention is based on the object of producing a stamp die, of the type mentioned in the introduction, for hot stamping or cold stamping, with which it is no longer necessary to make adjustments.

Said object is achieved according to the invention by means of the features of claim 1, that is to say in that the stamp die has a use layer with the surface structure, a base layer and at least one intermediate layer between the use layer and the base layer, the layers each being connected to one another by means of a heat-resistant flexible connecting film.

As a result of said multi-layer construction, the stamp die according to the invention has a degree of flexibility such that it is advantageously no longer necessary to make adjustments by placing suitable materials under the substrate to be stamped or under the stamp die.

In the stamp die according to the invention, it is preferable for the layers to be connected to one another in each case by means of an adhesive film. Said adhesive is preferably an epoxy resin adhesive. Another possibility in the stamp die according to the invention is for the individual layers to be connected to one another by means of elastomers.

In the stamp die according to the invention, it has proven to be expedient if the structured use layer has a wall thickness which is greater than the wall thickness of the at least one intermediate layer. As an example, the wall thickness of the use layer could be 2 mm and the wall thickness of the at least one intermediate layer could be 1.5 mm. It is of course also possible for the use layer and the at least one intermediate layer to have other wall thicknesses. The wall thickness of the use layer, the wall thickness of the at least one intermediate layer and the wall thickness of the base layer are preferably dimensioned so as to be matched to the respective application of the stamp die according to the invention. The same applies to the thickness of the connecting films between the respectively adjacent layers of the flexible stamp die according to the invention. The flexibility of the stamp die according to the invention can also be set as desired by means of the number of layers and the wall thicknesses thereof. The desired properties of the stamp die according to the invention can therefore be set, that is to say matched to the respective field of application, as desired by selecting and dimensioning the layers.

In the stamp die according to the invention, the surface structure of the use film can have a maximum depth which, at most, corresponds to, or is less than, the wall thickness of the use film. It is likewise possible for the surface structure of the use layer to have a maximum depth which is greater than the wall thickness of the use layer, so that the surface structure extends into the at least one intermediate layer.

In a stamp die according to the invention having the usual dimensions of known compact, single-piece stamp dies, it has proven to be advantageous if two or more than two intermediate layers are provided between the use layer and the base layer.

The use layer and the at least one intermediate layer and the base layer of the stamp die according to the invention can be composed of the same metals or metal alloys or of non-metallic materials. It is likewise possible for the use layer and the at least one intermediate layer and the base layer to be composed of different metals or metal alloys or non-metallic materials. In the stamp die according to the invention, brass, copper, steel or the like or non-metallic materials, for example, can be used for the use layer, the at least one intermediate layer and the base layer.

Further details, features and advantages can be gathered from the following description of an exemplary embodiment of the stamp die according to the invention, which is illustrated in section schematically, and not to scale, in the drawing.

The figure shows a stamp die 10 having a use layer 12 which is formed with a surface structure 14, 16. The surface structure 14 is a recessed surface structure and the surface structure 16 is an alternately recessed and elevated surface structure. The surface structures 14 and 16 have a maximum depth which is less than the wall thickness of the use layer 12. This, for example, is 2 mm.

The stamp die 10 also has a base layer 18 whose wall thickness is, for example, likewise 2 mm.

Two intermediate layers 20 are provided between the base layer 18 and the use layer 12. The use layer 12, the intermediate layers 20 and the base layer 18 are connected to one another by means of heat-resistant flexible connecting films 22, resulting overall in a stamp die 10 which is flexible to a limited extent, so that, when using the latter, it is no longer necessary to make adjustments by placing suitable materials—of the respectively required thicknesses—under the substrate to be stamped or under the stamp die.

The flexible connecting films 22 are preferably thin adhesive films of an epoxy resin adhesive.

The surface-structured use layer 12, the intermediate layers 20, which each have a wall thickness, for example, of 1.5 mm, and the base layer 18 can be composed of the same or different materials. Said materials can, for example, be brass, copper, steel or the like.

1. A stamp die having a surface structure for hot or cold stamping, the stamp die (10) having a use layer (12) with the surface structure (14, 16), a base layer (18) and at least one intermediate layer (20) between the use layer and the base layer (12 and 18), the layers (12, 20, 18) each being composed of a hard material and being connected to one another by means of a thin, heat-resistant flexible adhesive or elastomer film (22).

2. The stamp die as claimed in claim 1,
characterized
in that the adhesive of the respective adhesive film (22) is an epoxy resin adhesive.

3. The stamp die as claimed in claim 1,
characterized
in that the use layer (12) has a wall thickness which is greater than the wall thickness of the at least one intermediate layer (20), or than the sum of the wall thicknesses of the intermediate layers (20).

4. The stamp die as claimed in one of claims 1 to 3,
characterized
in that the surface structure (14, 16) of the use layer (12) has a maximum depth which, at most, corresponds to the wall thickness of the use film (12).

5. The stamp die as claimed in one of claims 1 to 3,
characterized
in that the surface structure (14, 16) of the use layer (12) has a maximum depth which is greater than the wall thickness of the use layer (12) and extends into the at least one intermediate layer (20).

6. The stamp die as claimed in one of claims 1 to 5,
characterized
in that at least two intermediate layers (20) are provided between the use layer (12) and the base layer (18).

7. The stamp die as claimed in one of claims 1 to 6,
characterized
in that the use layer (12) and the at least one intermediate layer (20) and the base layer (18) are composed of the same metals or of the same metal alloys or of the same non-metallic materials.

8. The stamp die as claimed in one of claims 1 to 6,
characterized
in that the use layer (12) and the at least one intermediate layer (20) and the base layer (18) are composed of different metals or of different metal alloys or of different non-metallic materials.
